(19) United States
(12) Patent Application Publication
(10) Pub. No.: US 2023/0354784 A1
(43) Pub. Date: Nov. 9, 2023

(54) METHOD FOR REDUCING THE NEGATIVE EFFECT OF HEAT ACCLIMATIZATION FOR HATCHING OF POULTRY HATCHING EGG

(71) Applicant: Zhejiang University, Hangzhou (CN)

(72) Inventors: Jinming PAN, Hangzhou (CN); Li ZENG, Hangzhou (CN); Qiong LIU, Hangzhou (CN); Tao WANG, Hangzhou (CN); Jian LI, Hangzhou (CN); Zunzhong YE, Hangzhou (CN)

(73) Assignee: Zhejiang University, Hangzhou (CN)

(21) Appl. No.: 18/344,913

(22) Filed: Jun. 30, 2023

Related U.S. Application Data
(63) Continuation of application No. PCT/CN2022/113167, filed on Aug. 18, 2022.

(30) Foreign Application Priority Data
May 5, 2022 (CN) 202210480242.X

(51) Int. Cl. A01K 41/02

(52) U.S. Cl. CPC A01K 41/023

(57) ABSTRACT

A method for reducing the negative effect of heat acclimatization for the hatching of a poultry hatching egg is provided. A special light source is used as an ambient light to hatch the poultry hatching egg. The special light source is light-emitting diode (LED) monochromatic blue light with a light intensity of 20 lux to 50 lux and a wavelength of about 450 nm, such that the light can reduce the negative effect of heat acclimatization at a hatching stage of the poultry hatching egg. The method can reduce the levels of oxidation products such as malondialdehyde (MDA) and corticosterone in a chicken embryo during heat acclimatization at the hatching stage of the poultry hatching egg and increase the expression levels of antioxidase and heat shock protein (HSP) genes, and the special light source reduces the metabolic heat production of the chicken embryo.

### CROSS REFERENCE TO THE RELATED APPLICATIONS

This application is the continuation application of International Application No. PCT/CN2022/113167, filed on Aug. 18, 2022, which is based upon and claims priority to Chinese Patent Application No. 202210480242.X, filed on May 5, 2022, the entire contents of which are incorporated herein by reference.

### TECHNICAL FIELD

The present disclosure relates to a method for reducing physiological characteristics of poultry in the field of light control for poultry egg hatching, and in particular, relates to a method for reducing a negative effect of heat acclimatization for the hatching of a poultry hatching egg.

### BACKGROUND

Climate change has become a major challenge for poultry production. An ascending ambient temperature can easily cause severe heat stress in chickens farmed at a high density, which can cause an economic loss as high as $128 million to $165 million per year. Particularly, in some tropical regions, it is very important to find measures to reduce a hazard caused by heat stress. The current environmental strategies include housing renovation, ventilation improvement, artificial shading, and the like. In addition to the above environmental control, heat acclimatization has proven to be an effective way to improve the heat resistance of hatched chickens.

Heat acclimatization refers to the intermittent exposure of eggs to a high-temperature environment during a chicken-hatching process. Studies have shown that, when chickens at a feeding stage encounter heat stress, the chickens that undergo heat acclimatization at a hatching stage have a low heat utilization, low-quality belly fat pad, prominent muscle growth, and short average fiber diameter. Compared with chicken embryos that do not undergo heat acclimatization, chicken embryos that undergo heat acclimatization have a lower metabolic rate and a lower calorific value.

However, heat acclimatization at a hatching stage will reduce the welfare and growth performance of animals. This is because the heat acclimatization itself can cause heat stress to an embryo to some degree, which is reflected in low egg yolk consumption and slow growth and development of embryos undergoing heat acclimatization. In addition, the heat acclimatization will break a balance between cellular antioxidants and reactive oxygen species (ROS) and increase an oxidation product concentration in an embryo to some extent, thereby causing oxidative stress in an embryonic liver.

### SUMMARY

An objective of the present disclosure is to provide a method for reducing a negative effect of heat acclimatization for the hatching of a poultry hatching egg, where light-emitting diode (LED) blue light with a wavelength of 400 nm to 480 nm and a light intensity of 10 lux to 800 lux is used to alleviate a specified degree of heat stress on an embryo caused by heat acclimatization at a hatching stage and improve the heat resistance at a hatching stage, which means that the animal welfare at a hatching stage of poultry farming is improved.

In the present disclosure, LED blue light control is combined with heat acclimatization at a hatching stage to alleviate a negative effect of the heat acclimatization at the hatching stage for an embryo; specifically, various indexes of a light environment are set, such as light cycle, light intensity, and wave spectrum, and an alleviation effect after irradiation is verified and analyzed.

The present disclosure solves the technical problem through the following technical solutions:

A method for reducing the negative effect of heat acclimatization for the hatching of a poultry hatching egg is provided, including conducting a light treatment during the hatching of the poultry hatching egg.

During the hatching of the poultry hatching egg, while the poultry hatching egg is subjected to heat acclimatization, specific light treatment is conducted.

During the hatching of the poultry hatching egg, while the poultry hatching egg is subjected to heat acclimatization, the poultry hatching egg is irradiated with blue light, which can increase a relative expression level of a heat shock protein (HSP) in an embryo of the hatching egg and reduce the concentrations of corticosterone and malondialdehyde (MDA), thereby controlling side effects caused by the heat acclimatization to ultimately improve the heat resistance of the hatching egg and hatched poultry.

The heat acclimatization includes, but is not limited to, intermittent exposure of the poultry hatching egg to a high-temperature environment at a hatching stage to allow a hatched chicken to have high heat resistance.

The high-temperature environment has a temperature of 40.0±1° C.

The blue light has a wavelength of 400 nm to 480 nm, and the light treatment is conducted for 1 h to 24 h every day with a light intensity of 10 lux to 800 lux. In the present disclosure, a special light source is used as an ambient light to irradiate the poultry hatching egg, and LED blue light can be used, such that the light can alleviate a negative effect of heat acclimatization at a hatching stage of the poultry hatching egg.

The light alleviates the negative effect of heat acclimatization at the hatching stage of the poultry hatching egg. Specifically, when used in actual hatching, the light treatment can reduce the levels of oxidation products such as MDA and corticosterone in embryos after heat acclimatization at a hatching stage, increase the expression levels of antioxidases, such as superoxide dismutase (SOD) and catalase, and increase the expression level of the HSP gene, thereby reducing the metabolic heat generation of embryos and alleviating oxidative stress of a liver tissue caused by heat acclimatization.

Lamps for the light treatment include, but are not limited to, an incandescent lamp, an LED lamp, an OLED lamp, a quantum LED lamp, and a fluorescent lamp.

Poultry refers to a chicken, but is not limited to, the chicken.

The light treatment of the poultry hatching egg can refer to a light treatment for the hatching of the poultry hatching egg in an incubator but is not limited thereto.

The present disclosure has found that conditions of the light treatment are related to the ability of the embryo of the poultry hatching egg to resist heat stress, and based on this relationship, a special light source is used to irradiate a poultry hatching egg at a hatching stage to reduce a negative effect of heat acclimatization for a chicken embryo, alleviate oxidative stress of liver tissue, and improve the animal welfare of poultry.

The present disclosure has the following beneficial effects:
1. In the method provided in the present disclosure, a special light source is used as ambient light for the hatching of a poultry hatching egg, which can effectively reduce a negative effect caused by heat acclimatization at a hatching stage, reduce the metabolic heat production of an embryo, and increase the expression levels of antioxidases and HSP, thereby improving the heat resistance.
2. In addition, the light treatment method of the present disclosure can effectively alleviate oxidative stress of liver tissue caused by heat acclimatization to a chicken embryo and improve the animal welfare of poultry farming.

### BRIEF DESCRIPTION OF THE DRAWINGS

FIG. 1 is a three-dimensional (3D) view illustrating a structure of the light environment-controlled hatching system of the present disclosure, where 1 represents an incubator, 2 represents an LED tube, 3 represents an egg-flipping iron frame, 4 represents an egg tray, and 5 represents a poultry hatching egg.

FIG. 2 is a side view illustrating a structure of the light environment-controlled hatching system of the present disclosure, where numerals in FIG. 2 are the same as in FIG. 1.

### DETAILED DESCRIPTION OF THE EMBODIMENTS

The embodiments of the present disclosure are described below, and the actual use of the present disclosure is not limited to the embodiments.

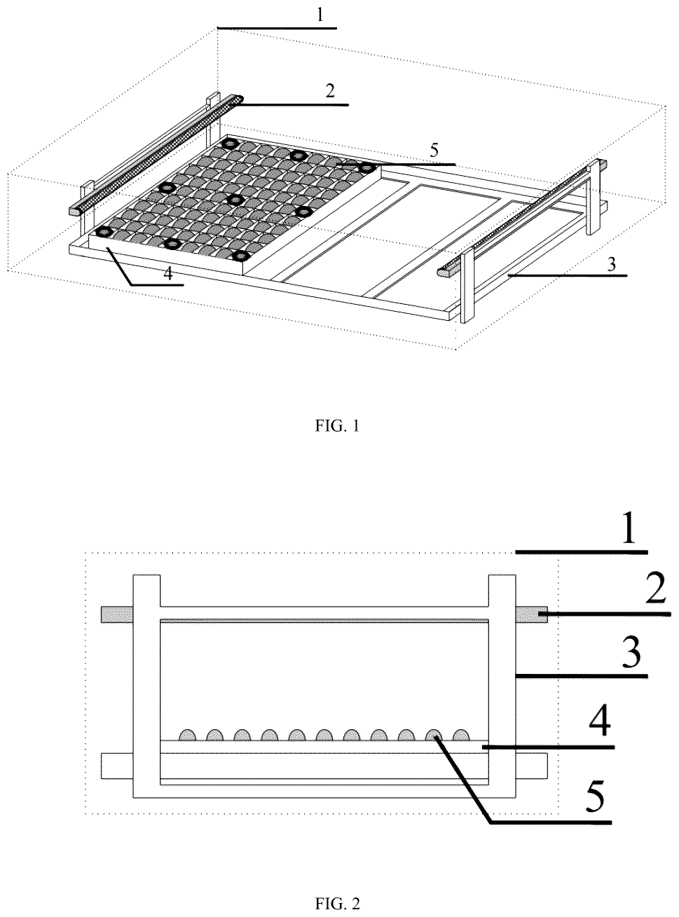

As shown in FIG. 1, an incubator with a temperature and humidity controllable is used as a hatching environment for a poultry hatching egg. In this embodiment, the incubator 1 has a size of 90 cm×62 cm×74 cm, and an egg-flipping iron frame 3 with a length of 78 cm and a width of 55 cm is placed in the incubator 1. An LED tube 2 is fixed at each of the two inner sides of the egg-flipping iron frame 3 to provide a light environment for a hatching experiment. A plurality of egg trays 4 is placed on the egg-flipping iron frame to hold and stabilize poultry hatching eggs 5. Four incubators each with such a configuration are provided to set up three experimental groups and a parallel control group.

The three experimental groups are as follows: LED blue light irradiation+heat acclimatization; LED blue light irradiation+no heat acclimatization; and LED white light irradiation+heat acclimatization. The parallel control group is as follows: LED white light irradiation+no heat acclimatization.

In a specific implementation, blue light used for the LED blue light irradiation group has a wavelength of about 450 nm and a light intensity of 20 lux to 50 lux; white light used for the LED white light irradiation group has a normal full-wavelength spectrum and a light intensity of 20 lux to 50 lux; in the heat acclimatization group, a temperature is 40.0±1° C. when heat acclimatization is conducted and a temperature is 37.6±1° C. when heat acclimatization is not conducted; and in the no heat acclimatization group, a temperature is always kept at 37.6±1° C. In all groups, the relative humidity is kept at 60±1%.

A specific experimental process is divided into three parts: pre-hatching, heat acclimatization, and sampling and detection.

800 hatching eggs of yellow-footed hemp breeders are selected for hatching, and 200 hatching eggs are randomly assigned to each incubator. The eggs each are flipped for 2 h daily from day 1 to day 18. The embryo survival is checked on day 18, and hatching eggs with dead embryos are eliminated. The temperature of each incubator is kept at 37.6±1° C. before heat acclimatization.

From day 14 to day 18 of hatching, hatching eggs of the heat acclimatization group each is subjected to heat acclimatization, that is, the hatching eggs each are exposed to an ambient temperature of 40.0±1° C. every day consecutively for 4 h, and after the heat acclimatization is completed, the temperature is reduced to 37.6±1° C.

The sampling and detection is conducted at the end of the entire heat acclimatization phase, namely, on day 18 of hatching. 24 eggs are randomly selected from each group for sampling. The collected samples are embryonic liver tissues, and are tested as follows: ½ of the liver tissues are tested by a biological diagnosis kit to determine the levels of oxidation products such as MDA and corticosterone and determine the activities of SOD and catalase; and ½ of the liver tissues are used to determine the gene transcription levels of HSP, heat shock factor (HSF), and antioxidases.

Test results are shown in Table 1.

TABLE 1
Oxidation product levels and heat resistance gene expression levels of chicken

| | | | HSP70 | HSP90 | HSF1 | HSF3 | SOD | CAT |
|---|---|---|---|---|---|---|---|---|
| | | MDA | (average | (average | (average | (average | (average | (average |
| | Corticoste- | (nmol/ | fold | fold | fold | fold | fold | fold |
| Group | rone (ng/g) | mg) | change) | change) | change) | change) | change) | change) |
| Blue light + heat acclimatization | 3.366 | 60.475 | 2.15 | 1.94 | 1.25 | 1.09 | 0.83 | 1.24 |
| Blue light + no heat | 2.670 | 52.789 | 1.15 | 1.08 | 0.99 | 1.70 | 1.12 | 1.13 |
| acclimatization | | | | | | | | |
| White light + heat | 3.764 | 69.815 | 2.98 | 2.30 | 1.21 | 2.06 | 0.71 | 0.90 |
| acclimatization | | | | | | | | |
| White light + no heat | 2.842 | 53.343 | 1.04 | 1.04 | 1.03 | 1.03 | 1.02 | 1.02 |
| acclimatization | | | | | | | | |

It can be seen from the results that the levels of oxidation products in the chicken embryos of the LED blue light irradiation+heat acclimatization group are significantly lower than that in the chicken embryos of the heat acclimatization group without LED blue light irradiation (P<0.01). It can be seen from the test results of gene transcription levels of embryonic liver cells that the LED blue light irradiation significantly increases the transcription levels of HSP 70 (P<0.01), HSP 90 (P<0.05), SOD (P<0.01), and catalase (P<0.01) genes.

It can be seen from the above results that the LED blue light irradiation+heat acclimatization at a hatching stage can significantly increase the expression levels of embryonic HSP and antioxidases and reduce the ROS content in vivo, thereby reducing a negative effect caused by heat acclimatization; and the LED blue light irradiation can alleviate oxidative stress of a chicken embryo liver caused by heat stress and improve the welfare of animal farming.

What is claimed is:

1. A method for reducing a negative effect of heat acclimatization for hatching of a poultry hatching egg, comprising:
conducting a light treatment during the hatching of the poultry hatching egg;
wherein during the hatching of the poultry hatching egg, while the poultry hatching egg is subjected to heat acclimatization, a specific light treatment is conducted, wherein a blue light is used in the specific light treatment, the blue light has a wavelength of 400 nm to 480 nm, and the light treatment is conducted for 1 h to 24 h every day with a light intensity of 10 lux to 800 lux.

2. The method for reducing the negative effect of heat acclimatization for the hatching of the poultry hatching egg according to claim 1, wherein during the hatching of the poultry hatching egg, while the poultry hatching egg is subjected to heat acclimatization, the poultry hatching egg is irradiated with the blue light.

3. The method for reducing the negative effect of heat acclimatization for the hatching of the poultry hatching egg according to claim 1, wherein the heat acclimatization comprises, but is not limited to, intermittent exposure of the poultry hatching egg to a high-temperature environment at a hatching stage to allow a hatched chicken to have high heat resistance.

4. The method for reducing the negative effect of heat acclimatization for the hatching of the poultry hatching egg according to claim 3, wherein the high-temperature environment has a temperature of 40.0±1° C.
